(19) United States
(12) Patent Application Publication
(10) Pub. No.: US 2013/0312970 A1
(43) Pub. Date: Nov. 28, 2013

(54) THICKENING OF FLUIDS

(71) Applicants: Valerie Lafitte, Stafford, TX (US); Laetitia Corde, Les Ulis (FR); Laurent Pirolli, Stafford, TX (US); Gary John Tustin, Sawston (GB); Bruno Drochon, Houston, TX (US)

(72) Inventors: Valerie Lafitte, Stafford, TX (US); Laetitia Corde, Les Ulis (FR); Laurent Pirolli, Stafford, TX (US); Gary John Tustin, Sawston (GB); Bruno Drochon, Houston, TX (US)

(73) Assignee: SCHLUMBERGER TECHNOLOGY CORPORATION, SUGAR LAND, TX (US)

(21) Appl. No.: 13/989,752

(22) PCT Filed: Nov. 22, 2011
(86) PCT No.: PCT/US11/61939

§ 371 Date: Aug. 2, 2013

(51) Int. Cl. C08K 5/55; E21B 43/25; C09K 8/88; C08K 3/20; C08K 5/19

(52) U.S. Cl. CPC C08K 5/55; C08K 3/20; C08K 5/19; C09K 8/887; E21B 43/25
USPC 166/305.1; 524/567; 524/555; 514/772.4; 514/782; 106/217.7; 510/438; 507/203; 507/211; 507/225

(57) ABSTRACT

An aqueous fluid contains an aqueous solution or dispersion of a polymer to thicken the fluid together with a cross linking agent to enhance the viscosity of the fluid by crosslinking the polymer, wherein the crosslinking agent comprises supporting structures bearing functional groups to react with the polymer molecules and has a mean particle size of 2 nanometer or more. The supporting structures may be nanoparticles and the functional groups may be boronic acid groups. The concentration of boron in a thickened fluid may be low and in some instances there is resistance to applied pressure. The fluid may be a hydraulic fracturing fluid.

### FIELD OF THE INVENTION

This invention is concerned with aqueous fluids rendered viscous by the incorporation of a polymeric thickening material which is cross-linked in order to increase the viscosity of the aqueous fluid. The invention has particular application in connection with wellbores drilled to access underground formations and in connection with the extraction of oil and natural gas via drilled wellbores. However, the invention may be applied in other fields where a viscous aqueous liquid is employed, such as cleaning compositions and water-based paints.

### BACKGROUND

It is well known to increase the viscosity of water or an aqueous solution by incorporating a polymer as a thickening agent. A number of polymers are known for this purpose including a number of polysaccharides. Viscosity can then be increased considerably, giving a viscoelastic gel, by cross-linking the polymer molecules. This has particular application in connection with the extraction of hydrocarbons such as oil and natural gas from a reservoir which is a subterranean geologic formation by means of a drilled well that penetrates the hydrocarbon-bearing reservoir formation. In this field, one commercially very significant application of thickened fluids is for hydraulic fracturing of the formation. The polymeric thickening agent assists in controlling leak-off of the fluid into the formation, it aids in the transfer of hydraulic fracturing pressure to the rock surfaces and it facilitates the suspension and transfer into the formation of proppant materials that remain in the fracture and thereby hold the fracture open when the hydraulic pressure is released.

Further applications of thickened fluids in connection with hydrocarbon extraction are acidizing, control of fluid loss, diversion, zonal isolation, and the placing of gravel packs. Gravel packing is a process of placing a volume of particulate material, frequently a coarse sand, within the wellbore and possibly extending slightly into the surrounding formation. The particulate material used to form a gravel pack may be transported into place in suspension in a thickened fluid. When it is in place, the gravel pack acts as a filter for fine particles so that they are not entrained in the produced fluid.

Common examples of polymeric thickening agents used in the thickened fluids mentioned above are galactomannan gums, in particular guar and substituted guars such as hydroxypropyl guar and carboxymethylhydroxypropyl guar. Cellulosic polymers such as hydroxyethyl cellulose may be employed, as well as synthetic polymers such as polyacrylamide.

Crosslinking of the polymeric materials then serves to increase the viscosity and proppant carrying ability of the fluid, as well as to increase its high temperature stability. Typical crosslinking agents comprise soluble boron, zirconium, and titanium compounds. Chromium and aluminium compounds have also been used.

The viscosity of these crosslinked gels can be reduced by mechanical shearing (ie they are shear thinning) but gels cross-linked with boron compounds have the advantage that they will reform spontaneously after exposure to high shear. This property of being reversible makes boron-crosslinked gels particularly attractive and they have been widely used.

It is generally desirable to achieve the desired viscosity with a low concentration of thickening materials so as to reduce cost of materials and reduce the amount of material which is delivered below ground and may need to be removed in a subsequent cleanup operation. Also, boron and metals, in sufficient concentration, can be toxic to the environment and so it is also desirable to minimise the amount of boron or metallic cross-linking agent which is used.

### SUMMARY

In a first aspect of this invention, an aqueous fluid comprising an aqueous solution or dispersion of a polymer and a cross linking agent to enhance the viscosity of the fluid by crosslinking the polymer is characterized in that the crosslinking agent comprises supporting structures bearing functional groups to react with the polymer molecules. The functional groups may react directly with the polymer, or may participate in a reaction with the polymer and a third material which then provides part of the connection to a polymer molecule.

In some embodiments of this invention, the fluid is a wellbore fluid intended for delivery via a wellbore to a subterranean location which may be a reservoir penetrated by the wellbore.

In a second aspect, this invention provides a method of treatment of a wellbore or a formation penetrated by a wellbore, comprising pumping into the wellbore a fluid comprising an aqueous solution or dispersion of a polymer and also a cross linking agent to enhance the viscosity of the fluid by crosslinking the polymer, characterized in that the crosslinking agent comprises supporting structures bearing functional groups to react with the polymer molecules.

It is envisaged that the supporting structures (and hence the crosslinking agent containing them) should have a minimum size which is larger than a small molecule. For instance an approximate molecular diameter of boric acid (obtained by adding the covalent bond lengths) is approximately 400 picometers, i.e. 0.4 nanometers. The cross-linking agents for this invention and the supporting structures within them may have at least one dimension which is at least 1 nanometer (1 nm), possibly at least 2 nm and possibly at least 4 or 5 nm. They may have two or possibly three orthogonal dimensions which are at least 1, 2, 4 or 5 nm. Whilst they may or may not have a spherical shape, they may have a particle size which is the diameter of an equivalent sphere, of at least 1 nm, possibly at least 2, 4 or 5 nm. In some forms of this invention the cross-linking agents for this invention and the supporting structures within them may have at least one dimension and/or a particle size which is at least 8 or 10 nm.

It is also envisaged that the crosslinking agents will have particle size, which is the diameter of an equivalent sphere, no larger than 1000 nm, possibly no larger than 200 nm or even not more than 100 nm.

The functional groups to react with polymer molecules may be covalently attached to the supporting structures and may possibly be attached to these supporting structures through linking groups.

Thus, cross-linking agents may have a particle size of 1 nm, 2 nm or 5 nm up to 100, 200 or 1000 nm and comprise (i) a supporting structure (ii) functional groups for binding to polymer molecules and possibly also (iii) linker groups connecting the functional groups to the structure. Linking groups may comprise aliphatic moieties, aromatic moieties or both. It will be appreciated that the functional groups for binding to the polymer which is to be crosslinked and thickened may be concentrated at the exterior of the supporting structure.

It is envisaged that the supporting structures (and hence the crosslinking agent containing them) should have a minimum size which is larger than a small molecule. For instance an approximate molecular diameter of boric acid (obtained by adding the covalent bond lengths) is approximately 400 picometers, i.e. 0.4 nanometers. The cross-linking agents and the supporting structures within them may have at least one dimension which is at least 1 nanometer (1 nm), possibly at least 2 nm and possibly at least 4 or 5 nm. They may have two or possibly three orthogonal dimensions which are at least 1, 2, 4 or 5 nm. Whilst they may or may not have a spherical shape, they may have a particle size, which is expressed as the diameter of an equivalent sphere, of at least 1 nm, possibly at least 2, 4 or 5 nm. In some embodiments the cross-linking agents and the supporting structures within them may have at least one dimension and/or a particle size which is at least 8 or 10 nm.

It is also envisaged that the crosslinking agents will have particle size, which is the diameter of an equivalent sphere, no larger than 1000 nm, possibly no larger than 200 nm or even not more than 100 nm.

The polymer to be crosslinked may be a polysaccharide or chemically modified polysaccharide in which case the functional groups for attaching to hydroxyl groups of the polymer may be an organo-boron species or may incorporate a metal such as zirconium or aluminium. A different category of polymers which may be crosslinked to increase viscosity is polyacrylamides. For cross-linking polyacrylamides, phenolic functional groups may be employed.

Although the functional groups provided in the crosslinking agents may attach to polymer molecules by similar chemistry to that for conventional cross-linking agents, and so may contain boron or a metal, embodiments of this invention show an unexpected improved efficacy of crosslinking with the advantage that the amount of boron or metal used in order to achieve a target viscosity can be lower than when a conventional cross-linking agent is used.

When the functional groups contain boron, the concentration of boron in the fluid may lie in a range from 0.5 to 50 ppm elemental boron and possibly 0.5 up to 10 ppm or even no more than 5 ppm. When the functional groups contain a metal, the concentration of this metal in the fluid may lie in a range from 0.5 to 50 ppm by weight elemental metal, possibly not over 20, 10 or even 5 ppm. In the event that boron and one or more metals at present, the concentration of all of them together may lie within the same range of 0.5 ppm up to 50, 20, 10 or even 5 ppm.

This also means that the proportion of boron or metal to the polymer to be crosslinked may be low. Thus the amounts of the polymer and boron in the fluid may be such that the amount of boron is not more than 0.002 or 0.001 times the amount of the polymer. Expressing this in terms of concentrations, the content of boron or metal may be not more than 2 ppm, possibly not more than 1 ppm for each gram of polymer in 1 liter of solution. For a solution containing 4 gm/liter of polymer to be crosslinked this would be not more than 8 ppm, possibly not more than 4 ppm boron or metal in the solution. The quantity of cross linking agent (supporting structure plus functional groups) may be no more than 30%, possibly no more than 20, 15 or 10% by weight of the polymer to be crosslinked.

We have also observed, unexpectedly, that satisfactory cross-linking can occur when the polymer which is to be cross-linked is at a lower concentration than is usually required. Concentration of polysaccharide or chemically modified polysaccharide in the fluid may be from 0.5 or 1 g/liter up to 5, 10 or 20 g/liter, but quite possibly not over 2 g/liter. The concentration of polyacrylamide may also lie in these ranges.

A third unexpected advantage of embodiments of crosslinking agent is that the viscosity of polymers cross-linked by them remains stable under pressure (such as hydrostatic pressure downhole) whereas viscosity achieved by cross-linking with conventional boron-based cross-linking agents is not maintained under pressure. Thus it is possible to have the desirable feature that cross linking with a boron-based cross-linking agent is reversible (reducing under shear but then re-forming) without undesirable loss of viscosity under hydrostatic pressure.

In some embodiments of the method of this invention it is a feature that the fluid is subjected to a pressure, such as hydrostatic pressure from the depth downhole, which exceeds a certain minimum. This minimum may be 2000 psi (13.79 MPa) or 5000 psi but may be higher such as 80 MPa (about 12,000 psi) or even 100 MPa.

In some embodiments of the invention, the crosslinking agent contains material which serves an additional purpose (something other than binding to polymer molecules) so that the crosslinking agent is multifunctional. For instance the crosslinking agent may incorporate a detectable tracer material. This could be used to monitor the presence/amount of cross-linked polymer in fluid flowing out of a well, for instance during flow back after hydraulic fracturing. Such a tracer could be a coloured material such as a dye or a fluorescent material and the presence of the tracer could be determined by spectroscopy. Another possibility is that a tracer could be provided by a redox active material, such as ferrocene or a ferrocene derivative, detectable by electrochemistry. In either case the tracer material could be incorporated into nanoparticles during their preparation, for example by incorporating a comonomer with the tracer covalently attached to it. However, we have observed that hydrophobic tracer can be absorbed into nanoparticles with a hydrophobic core and it is then retained well by the nanoparticles, thus providing the particles with a detectable tracer material in them. Further possibilities are that the crosslinking agents may incorporate or be attached to corrosion inhibitors or chelating agents for scale-forming ions.

Although wellbore fluids for delivery to a subterranean location have been discussed above, other applications of this invention are products where a thickened fluid is required. Many detergent compositions and cosmetic compositions are thickened fluids. For instance household cleaning compositions including hard surface compositions containing suspended solid, personal washing compositions such as shower gels, shampoos and conditioners, roll-on deodorants and others. Another area where thickened aqueous liquids are employed are water-based paints containing pigment.

### BRIEF DESCRIPTION OF THE DRAWINGS

FIG. 1 very diagrammatically illustrates a nanoparticle;

FIG. 2 is a reaction scheme for the preparation of nanoparticles;

FIG. 3 illustrates attachment to a guar molecule;

FIG. 4 illustrates the attachment of phenolic groups to nanoparticles;

FIG. 5 illustrates attachment to polyacrylamide in the presence of formaldehyde;

FIG. 6 shows the result of a nanoparticles size measurement;

FIG. 7 is a graph of viscosity of thickened guar, described in Example 3;

FIG. 8 is a graph of viscosity of thickened guar, described in Example 4;

FIG. 9 is a graph of viscosity of thickened hydroxypropyl guar, described in Example 6;

FIGS. 10 and 11 are graphs of viscosity under pressure, described in Example 11;

FIGS. 12 and 13 are graphs of viscosity under pressure, described in Example 12;

FIG. 14 is a graph of viscosity of thickened guar, described in Example 13;

FIG. 15 shows a voltammogram obtained with nanoparticles doped with ferrocene; and

FIG. 16 shows the structure of a crosslinking agent which is a dendrimer.

### DETAILED DESCRIPTION

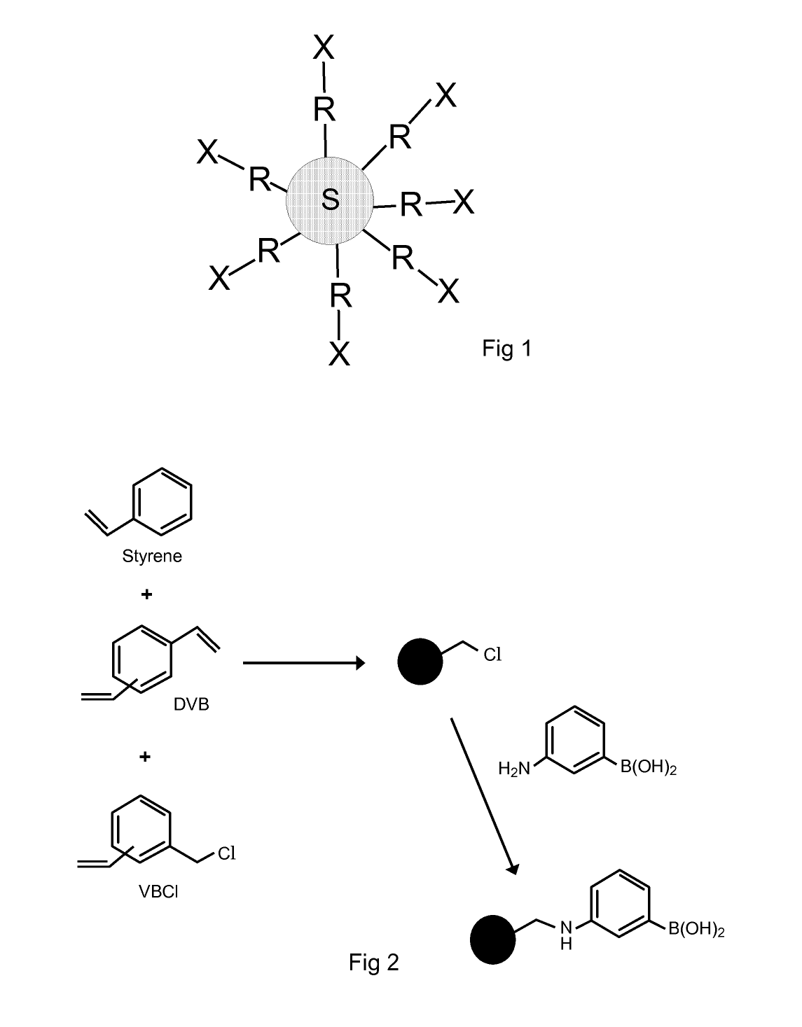

A nanoparticle for crosslinking polymer is illustrated very diagrammatically by FIG. 1. The particle has a core S with functional groups X for attaching to polymer molecules. The groups X are covalently bound to the core through linking groups R.

There are a number of possibilities for sub-micron sized supporting structures which may be used in this invention. One possibility is nanoparticles, which may be formed of an inorganic material such as silica, alumina or a metal or may be formed by an organic polymer. Nanoparticles are typically spherical or approximately spherical, so that their longest dimension is not more than double their smallest dimension orthogonal to the longest. Nanoparticles which provide submicron structures for this invention may be formed from a single material, or may have a core-shell structure with one material enclosing another. It would be possible within the scope of the invention for nanoparticles to be a hollow shell enclosing a core cavity which is filled with a mobile liquid. Whether the nanoparticles are simply bodies of a single material, or have a shell around a core, or have a hollow shell, they will, in accordance with this invention, be provided at their exterior with functional groups to react with polymer molecules.

Another possibility for sub-micron supporting structures is a dendrimer or other highly branched polymer, with the required functional groups attached to the ends of the branching chains of this polymer. Some literature articles consider highly branched macromolecules such as dendrimers to be species of nanoparticles, but others do not. Dendrimers may be formed by a so-called divergent process in which successive polymerization steps add to an existing core and also introduce further chain branching. The result is a macromolecule which adopts a spherical shape when it is free to do so, for instance when in solution. The diameter of a dendrimer molecule may well exceed 4 nm. For example, polyaminoanine (PAMAM) dendrimers are quoted as having a molecular weight of approximately 29,000 and a diameter of 5.4 nm after five polymerization steps and a molecular weight of about 900,000 and a diameter of 13.5 nm after ten polymerization steps. Conversely, dendrimers may be made by a convergent process in which branched molecules are linked by other branched molecules until a central point is reached.

Hyperbranched polymers may also be made by polymerization processes in which joining a monomer unit to an existing polymer extends the polymer and also introduces chain branching. However, in contrast with the creation of dendrimers the polymerization may not be controlled as separate steps and the resulting polymers may have more variation in structure than dendrimers. Nevertheless they can have molecular dimensions in excess of 1 nm and can be used for this invention by providing the required functional groups at the ends of the branched chains. One review of routes to highly branched polymers is C. R. Yates and W. Hayes, “Synthesis and Applications of Hyperbranched Polymers” European Polymer Journal vol 40, pp 1257-1281 (2004).

These various possibilities for the structure within a crosslinking agent will vary in rigidity. A nanoparticle formed from a metal or other inorganic solid, or from a crosslinked organic polymer will be expected to be a rigid structure. However, a nanoparticle formed by a shell with a hollow interior may be somewhat flexible. Dendrimers and hyperbranched polymers often have flexibility in their branched chains, and so have a deformable shape.

One suitable technique for determining the particle size of crosslinking agents is photon cross correlation spectroscopy (PCCS) which is a development of an earlier method know as photon correlation spectroscopy (PCS) and also as dynamic light scattering (DLS). This technique enables the determination of mean particle diameter and distribution of diameters. Instruments for carrying out PCCS are marketed by Sympatec GmbH, Clausthal-Zellerfeld, Germany.

Mean diameter d₅₀ is a value of particle size such that 50 wt % of the particles have volume larger than a sphere of diameter d₅₀ and the remaining particles are smaller than the volume of a sphere of diameter d₅₀. For crosslinking agents of substantially uniform composition, percentages by weight and by volume are the same.

Particle size distribution may be indicated by the values of d₁₀ and d₉₀ measured in the same way. 10 wt % of the particles in a sample have a size smaller than d₁₀. 90 wt % are smaller than d₉₀ and so 10 wt % are larger than d₉₀. The closer together are the values of d₁₀ and d₉₀, the narrower is the particle size distribution. The particle size distribution of the crosslinking agents may be such that d₁₀ is at least 1 nm, possibly at least 3 nm or 5 nm and d₉₀ is not more than 1000 nm, possibly not more than 500, 200 or even 100 nm. Size distribution may also be expressed as polydispersity, defined as [(d₉₀-d₁₀)/d₅₀]×100%.

The crosslinking agents have functional groups for attaching to the polymer which they crosslink. Sub-micron supporting structures (such as a nanoparticle or branched polymer molecule) may carry at least 8 or 10 functional groups per individual supporting structure, and possibly more such as at least 100 or perhaps at least 1000.

A polysaccharide to be crosslinked may be a galactomannan gum, and the commonly used example of such gums is guar. Various chemical modifications of guar are available and may be used. One is the introduction of hydroxyl-alkyl substituent groups. Hydroxypropyl guar is sometimes referred to as “hydrated guar”. Another well known substituent group is carboxyalkyl, usually carboxymethyl. Other polysaccharides which have been used as thickening agents, and which may be used in embodiments of this invention, are xanthan, scleroglucan, diutan and cellulose. These may also be chemically modified with hydroxyalkyl or carboxyalkyl groups.

If the polymer to be cross-linked is guar, some other polysaccharide or a chemically modified form of guar or other polysaccharide, the functional groups for attaching to hydroxyl groups of the polymer may be an organo-boron species or may incorporate a metal which is used in a conventional cross-linking agent, such as zirconium or aluminium.

If the polymer to be crosslinked is a polyacrylamide, which includes polymers and copolymers of acryamide and of alkylacrylamides such as methacrylamide, the functional groups may be phenolic and the cross-linking reaction could then be a reaction of the crosslinking agent bearing phenolic groups, the polyacrylamide and an aldehyde, notably formaldehyde (which may be provided by a precursor which decomposes to formaldehyde).

As mentioned, the supporting structures within the crosslinking agents may be composed of a range of materials and take a number of forms. However, it may be convenient to use nanoparticles formed from an organic polymer which is crosslinked. Organic monomers can be polymerised as nanoparticles by polymerisation while dispersed as the discontinuous phase of an emulsion. In some embodiments the supporting structures are nanoparticles formed by polymerisation of monomers dispersed as the oil phase of an oil-in-water emulsion. To give rigid nanoparticles, the monomers which are polymerized into nanoparticles may have a significant proportion of crosslinker, such as at least 20 mole % or at least 30 mole % of a crosslinking monomer.

Provision of a nanolatex (ie a suspension of nanoparticles) with the required functionality for attaching to polymer molecules may be accomplished by a two-stage preparation. In the first stage a nanolatex with reactive functional groups is prepared. Then in a second stage reactive groups at the surface of the nanoparticles are converted to provide the required functionality for attaching to polymer molecules.

A polymeric nanolatex may be prepared by polymerizing a monomer, mixed with a crosslinking agent and a co-monomer able to introduce the reactive functional groups. One possibility is to use styrene as the monomer, with divinylbenzene as the crosslinking agent and with vinyl benzyl chloride as a co-monomer to introduce reactive chlorine atoms.

FIG. 2 shows an overall reaction scheme for making nanoparticles. The core of the particles is a polymer of styrene cross-linked with divinylbenzene (DVB) and incorporating a small amount of vinylbenzyl chloride. A mixture of these monomers and a photo initiator is dispersed as the oil phase of an oil-in-water micro emulsion where the aqueous continuous phase is an aqueous solution of cationic surfactant. Polymerisation is brought about by exposure to light. The result is a nanolatex (a suspension of nanoparticles) in which the nanoparticles are cross-linked polystyrene with methylene chloride groups attached to some aromatic rings of the polystyrene. Here it is denoted as NL-CH₂Cl.

These nanoparticles are then reacted with an organic boron compound incorporating a boronic acid group —B(OH)₂ and a reactive amino group leading to nanoparticles with boronic acid moieties covalently attached through linking groups which contain a secondary amino group. These nanoparticles are denoted as NL-B(OH)₂.

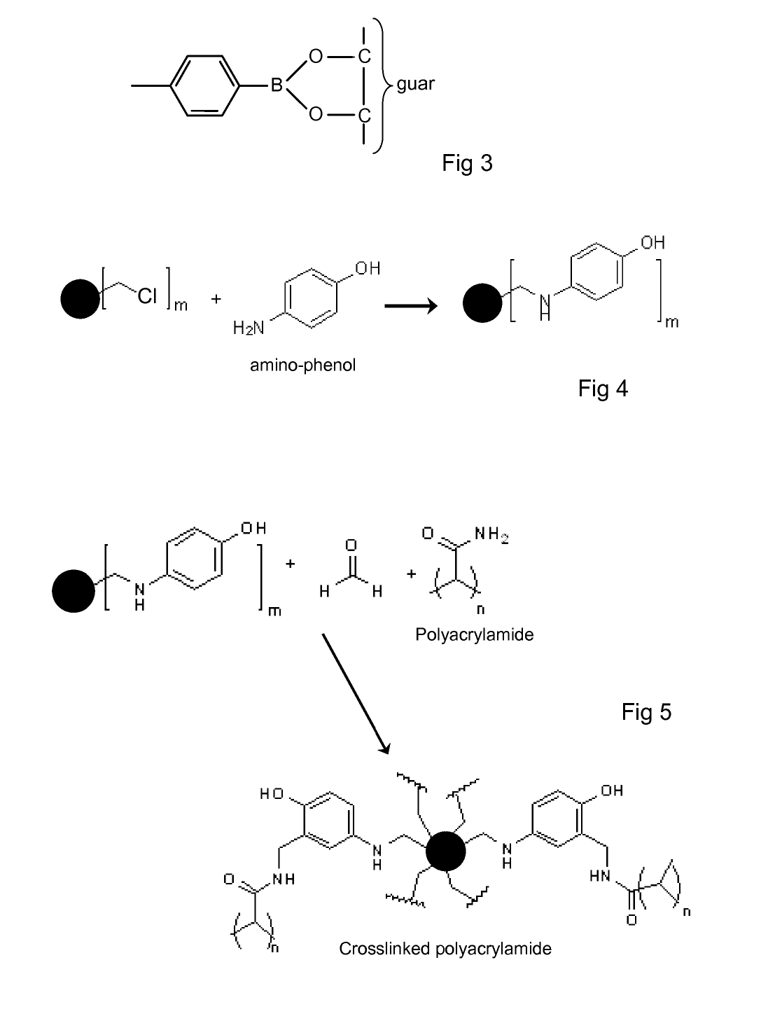

Attachment of one —B(OH)₂ group to two adjacent hydroxy groups of a guar molecule is illustrated by FIG. 3. Cross-linking takes place because a nanoparticle carries many —B(OH)₂ groups able to attach to many guar molecules.

FIG. 4 illustrates the formation of nanoparticles with phenolic groups suitable for attaching to polyacrylamide molecules. NL-CH₂Cl is prepared as shown in FIG. 2. It is then reacted with aminophenols as shown in FIG. 4. The phenolic groups can then participate in a known reaction with formaldehyde (usually provided as an aqueous solution) and the amide groups of polyacrylamide molecules as shown by FIG. 5. This coupling of phenolic functional groups to polyacrylamide by means of formaldehyde is an instance of functional groups attaching to polymer through a link provided by a third material.

A wellbore fluid embodying the present invention may include other constituents in addition to those already mentioned. One additional constituent which may be included is a breaker. The purpose of this component is to “break” or diminish the viscosity of the fluid so that this fluid is more easily recovered from the formation during cleanup. The breaker degrades the polymer to reduce its molecular weight. If the polymer is a polysaccharide, the breaker may be a peroxide with oxygen-oxygen single bonds in the molecular structure. These peroxide breakers may be hydrogen peroxide or other material such as a metal peroxide that provides peroxide or hydrogen peroxide for reaction in solution. A peroxide breaker may be a so-called stabilized peroxide breaker in which hydrogen peroxide is bound or inhibited by another compound or molecule(s) prior to its addition to water but is released into solution when added to water.

Examples of suitable stabilized peroxide breakers include the adducts of hydrogen peroxide with other molecules, and may include carbamide peroxide or urea peroxide (CH₄N₂O.H₂O₂), percarbonates, such as sodium percarbonate (2Na₂CO₃.3H₂O₂), potassium percarbonate and ammonium percarbonate. The stabilized peroxide breakers may also include those compounds that undergo hydrolysis in water to release hydrogen peroxide, such sodium perborate. A stabilized peroxide breaker may be an encapsulated peroxide. The encapsulation material may be a polymer that can degrade over a period of time to release the breaker and may be chosen depending on the release rate desired. Degradation of the polymer can occur, for example, by hydrolysis, solvolysis, melting, or other mechanisms. The polymers may be selected from homopolymers and copolymers of glycolate and lactate, polycarbonates, polyanhydrides, polyorthoesters, and polyphosphacenes. The encapsulated peroxides may be encapsulated hydrogen peroxide, encapsulated metal peroxides, such as sodium peroxide, calcium peroxide, zinc peroxide, etc. or any of the peroxides described herein that are encapsulated in an appropriate material to inhibit or reduce reaction of the peroxide prior to its addition to water.

The peroxide breaker, stabilized or unstabilized, is used in an amount sufficient to break the heteropolysaccharide polymer or diutan. This may depend upon the amount of heteropolysaccharide used and the conditions of the treatment. Lower temperatures may require greater amounts of the breaker. In many, if not most applications, the peroxide breaker may be used in an amount of from about 0.001% to about 20% by weight of the treatment fluid, more particularly from about 0.005% to about 5% by weight of the treatment fluid, and more particularly from about 0.01% to about 2% by weight of the treatment fluid. The peroxide breaker may be effective in the presence of mineral oil or other hydrocarbon carrier fluids or other commonly used chemicals when such fluids are used with the heteropolysaccharide.

Breaking aids or catalysts may be used with the peroxide breaker. The breaker aid may be an iron-containing breaking aid that acts as a catalyst. The iron catalyst is a ferrous iron (II) compound. Examples of suitable iron (II) compounds include, but are not limited to, iron (II) sulfate and its hydrates (e.g ferrous sulfate heptahydrate), iron (II) chloride, and iron (II) gluconate. Iron powder in combination with a pH adjusting agent that provides an acidic pH may also be used. Other transition metal ions can also be used as the breaking aid or catalyst, such as manganese (Mn).

Other materials which may included in a wellbore fluid include electrolyte, such as an organic or inorganic salt, friction reducers to assist flow when pumping and surfactants.

A wellbore fluid may be a so-called energized fluid formed by injecting gas (most commonly nitrogen, carbon dioxide or mixture of them) into the wellbore concomitantly with the aqueous solution. Dispersion of the gas into the base fluid in the form of bubbles increases the viscosity of such fluid and impacts positively its performance, particularly its ability to effectively induce hydraulic fracturing of the formation, and capacity to carry solids. The presence of the gas also enhances the flowback of the fluid when this is required. In a method of this invention the wellbore fluid may serve as a fracturing fluid or gravel packing fluid and may be used to suspend a particulate material for transport down wellbore. This material may in particular be a proppant used in hydraulic fracturing or gravel used to form a gravel pack. The commonest materials used as proppant or gravel is sand of selected size but ceramic particles and a number of other materials are known for this purpose.

Wellbore fluids in accordance with this invention may also be used without suspended proppant in the initial stage of hydraulic fracturing. Further applications of wellbore fluids in accordance with this invention are in modifying the permeability of subterranean formations, and the placing of plugs to achieve zonal isolation and/or prevent fluid loss.

For some applications a fiber component may be included in the treatment fluid to achieve a variety of properties including improving particle suspension, and particle transport capabilities, and gas phase stability. Fibers used may be hydrophilic or hydrophobic in nature. Fibers can be any fibrous material, such as, but not necessarily limited to, natural organic fibers, comminuted plant materials, synthetic polymer fibers (by non-limiting example polyester, polyaramide, polyamide, novoloid or a novoloid-type polymer), fibrillated synthetic organic fibers, ceramic fibers, inorganic fibers, metal fibers, metal filaments, carbon fibers, glass fibers, ceramic fibers, natural polymer fibers, and any mixtures thereof. Particularly useful fibers are polyester fibers coated to be highly hydrophilic, such as, but not limited to, DACRON® polyethylene terephthalate (PET) fibers available from Invista Corp., Wichita, Kans., USA, 67220. Other examples of useful fibers include, but are not limited to, polylactic acid polyester fibers, polyglycolic acid polyester fibers, polyvinyl alcohol fibers, and the like. When used in fluids of the invention, the fiber component may be present at concentrations from about 1 to about 15 grams per liter of the liquid phase, in particular the concentration of fibers may be from about 2 to about 12 grams per liter of liquid, and more particularly from about 2 to about 10 grams per liter of liquid.

### Example 1

Nanoparticles functionalised with boronic acid groups were prepared in two stages. In a first stage a nanolatex with reactive benzyl chloride functionality was prepared. 3.4 mg of 2,2-dimethoxy-2-phenylacetophenone (0.016 mol/mol of monomers) to serve as photoinitiator for polymerisation were added to a mixture of monomers containing 3.2 g of styrene (3.1×10⁻² mol), 4.1 g of divinylbenzene (3.1×10⁻² mol) and 1.7 g of vinylbenzyl chloride (1.1×10⁻² mol). Thus the molar proportions of these monomers were:

Styrene 41%

Divinyl benzene (which forms crosslinks) 42%

Vinylbenzyl chloride 15%.

A clear transparent microemulsion was prepared by adding the mixture of monomers (9 g in total) under gentle magnetic stirring to 200 g of 15 wt % aqueous dodecyltrimethylammonium bromide (DTAB). After mixing, the freshly prepared solution was transferred into a round bottom flask and degassed with nitrogen for 30 min. Polymerization was then performed at room temperature under 100 W white lamp for 26 hours. A stable, translucent, bluish suspension of reactive nanoparticles containing benzyl chloride functional groups (designated as latex NL-CH₂Cl) was obtained.

The second step was functionalisation with boronic acid groups. For this, 167 mg of 3-aminophenylboronic acid monohydrate (1.08×10⁻³ mol) and 200 microliter of sodium hydroxide 5N (10⁻³ mol) were added to 10 g of the nanolatex NL-CH₂Cl prepared above. The calculated quantity of chlorine present was 0.53×10⁻³ gram atom, and so the aminophenylboronic acid was in excess. The mixture was stirred at room temperature in the dark for 5 days to give an orange suspension. The resulting nanolatex NL-B(OH)₂ was purified by dialysis against a 15 wt % aqueous solution of DTAB using a cellulose membrane giving a molecular weight cut off of 10,000.

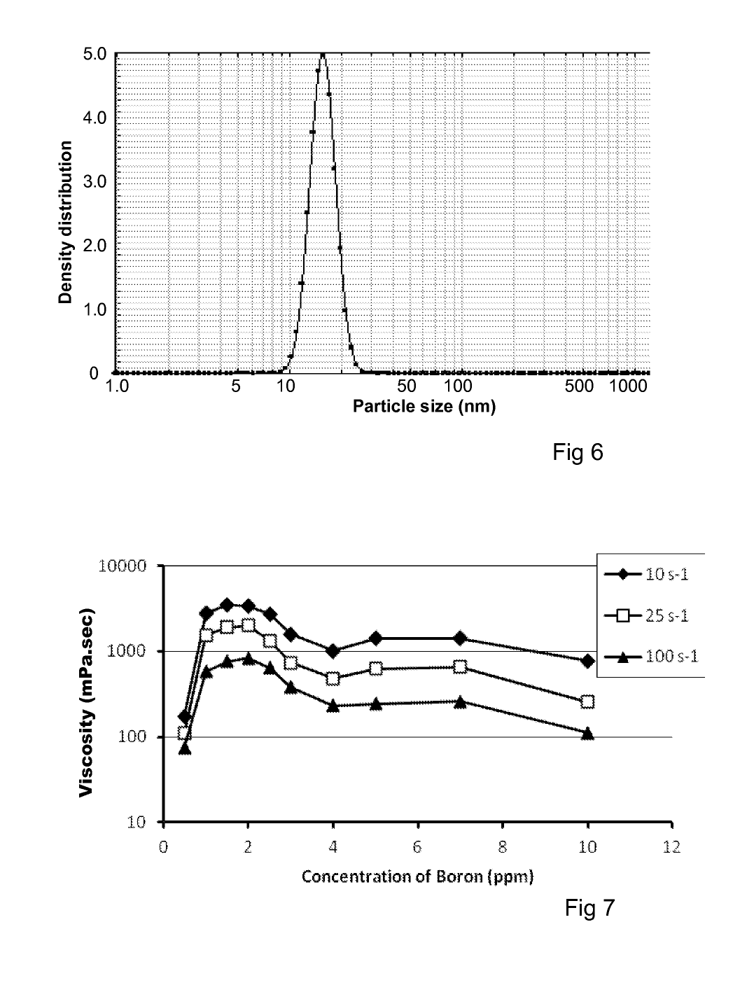

The particle size of the nanoparticles in the purified nanolatex was determined by PCCS. The measurement result is shown in FIG. 6. The mean particle diameter d₅₀ was 14.4 nm. As to size distribution, d₁₀ was larger than 8 nm and d₉₀ was less than 40 nm. Polydispersity calculated by the software of the PCCS instrument was about 13.9%.

The amount of boron in the aqueous NL-B(OH)₂ nanolatex was determined by inductively coupled plasma mass spectroscopy (ICP-MS) and found to be 30 ppm±2 ppm of elemental boron in the aqueous suspension.

By calculation from the weights of monomers, the weight of elemental chlorine in the polymer solids of the NL-CH₂Cl nanolatex was 0.396 g. If every chlorine atom had been replaced by a phenylboronic acid group, the amount of elemental boron in the NL-B(OH)₂ nanolatex would be 0.120 g in 9 g polymer solids, corresponding to a concentration of elemental boron in the nanolatex of 576 ppm. Since the aminophenylboronic acid had been used in excess and the measured boron concentration was only 30 ppm, it is apparent that only about 1 in 20 of the chlorine atoms in the NL-CH₂Cl nanoparticles was replaced with a boron containing group. This is consistent with reaction of the chlorine atoms at the surface of the nanoparticles but not within their interior.

### Example 2

The preparation of nanolatex was carried out as in Example 1, using smaller proportions of the divinyl benzene which acts as crosslinking agent in the mixture of monomers. It was observed that particle size reduced as the content of divinyl benzene increased from zero up to a concentration of about 33 mole % divinyl benzene in the monomer mixture. This was attributed to a reduction in the particle size as the amount of crosslinking increased. Above about 33 mole % divinyl benzene the particle size remained almost constant, indicating that maximum cross linking was being achieved.

### Example 3

Nanoparticles prepared as in Example 1 were used at a range of concentrations to crosslink unmodified guar.

An aqueous guar solution was first prepared by mixing guar powder with de-ionised water in a Waring blender for 30 minutes, during which time the cationic surfactant DTAB was added. The amounts were chosen to provide a solution containing guar at a concentration of 4 gm/liter, equivalent to 33 lbs per 1000 US gallons and DTAB at 2 wt %.

For each test a quantity of nanoparticles suspension was added to 15 ml of the guar solution. The quantities of nanoparticles suspension were chosen to provide boron concentrations from 0.5 to 10 ppm in the crosslinked gel. Next a small amount of sodium hydroxide (1N) was added in order to raise the pH above 9.5 and so allow crosslinking and thickening to begin. After 7 minutes viscosity was measured at 25° C. at shear rates of 10, 25 and 100 sec⁻¹. The results are shown in FIG. 7.

As can be seen, maximum viscosity is achieved with 2 to 3 ppm boron. Higher concentrations of the nanoparticles, giving higher concentrations of boron, did not raise the viscosity further.

### Example 4

Guar solution containing 4 gm/liter (equivalent to 33 lbs guar per 1000 US gallons) was prepared as in the previous example and nanoparticles suspension was added in sufficient amount to give 3 ppm boron. As a comparison, inorganic borate was added to a quantity of the same guar solution so as to give a boron concentration of 60 ppm. Portions of each mixture were diluted with 2 wt % DTAB solution so as to provide lower concentrations of guar and boron, with the same guar to boron ratio and a constant DTAB concentration. The lowest guar concentration was 1 gm/liter containing 0.75 ppm boron as nanoparticles or 15 ppm boron as borate.

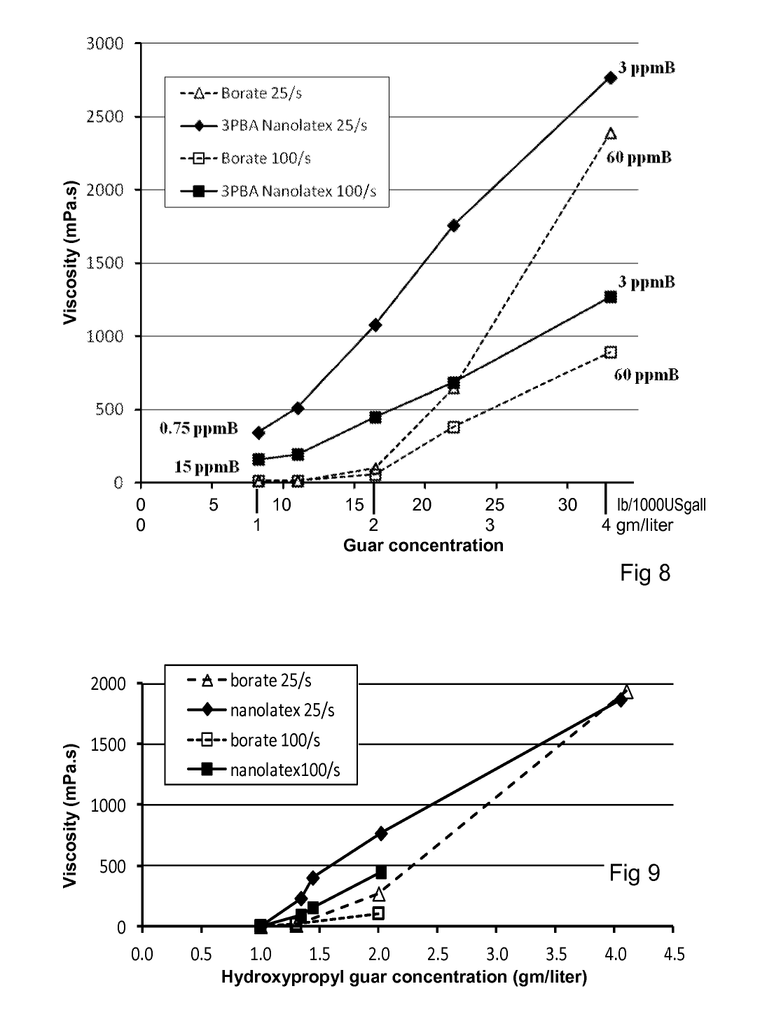

After mixing, the pH was raised above 9.5 to allow crosslinking and thickening to occur, and after a delay of 7 minutes, viscosities were measured at 25° C. at shear rates of 25 and 100 sec⁻¹ The results are shown in FIG. 8 where solid lines show data for nanoparticles and broken lines show the data points for inorganic borate.

It can be seen that nanoparticles gave the same or greater viscosity with twenty times less boron. Moreover with nanoparticles there was crosslinking and thickening at only 1 gm/liter guar whereas borate gave negligible thickening at guar concentrations of 2 gm/liter and below.

### Example 5

Samples of nanolatex were prepared by the procedure of Example 1, varying the length of times for the functionalisation with boronic acid groups from one to seven days. It was found that this led to variation in the amount of boron in the nanolatex.

A sample of purified nanolatex, which had been prepared with functionalisation over seven days was found to contain 45 ppm boron. 10 gm of this latex was evaporated to dryness and found to contain 0.132 gm solids. Estimating the specific gravity of the solids as 1.05 and taking particle diameter as 15 nm, the volume and weight of a nano particle were calculated as:

Volume=1.77×10⁻³⁰ m³ and mass=1.85×10⁻¹⁸ gm

Since 1 gm nanolatex contained 13.2 mg of nanoparticles and had a boron content of 45 ppm it was calculated, using Avogadro's number, that there were an average of approximately 350 boron atoms per nanoparticle and therefore an equal average of approximately 350 boronic acid functional groups attached to each nanoparticle. Corresponding calculations indicated approximately 200 boronic acid groups per nanoparticle after functionalisation for one day and approximately 250 boronic acid groups if functionalisation was carried out for four or five days.

Nanolatices functionalised for these lengths of time were used to thicken guar solutions following the procedure of Example 2 and it was found that all of them gave maximum viscosity at about 1.5 to 3 ppm boron with 4 gm/liter of guar.

### Example 6

Nanoparticles prepared as in Example 1 were used to cross-link solutions of hydroxypropyl guar (HPG) at various concentrations. Comparative tests were also carried out using boric acid solution in place of the suspension of nanoparticles.

HPG solution was prepared by mixing HPG powder with de-ionised water containing the cationic surfactant DTAB while stirring for two hours. The amounts were chosen to provide a stock solution containing DTAB at 2 wt %. and HPG at a concentration of 4 gm/liter, equivalent to 33 lbs per 1000 US gallons.

For each test a quantity of nanoparticles suspension or boric acid solution was added to 15 ml HPG solution. In some tests the mixture was diluted with water to give solutions of lower HPG and DTAB concentration, while keeping the ratio of nanoparticles to HPG constant. Next a small amount of sodium hydroxide (1N) was added in order to raise the pH above 9.5 and so allow crosslinking and thickening to begin. After six minutes, viscosity was measured at 25 s⁻¹ and (when possible) at 100 s⁻¹ using a Bohlin rheometer.

In these tests the amount of nanoparticle suspension added to 15 ml of the stock solution was kept constant at 1.5 ml giving 3 ppm boron in the mixed solution before any dilution. In the comparative experiments 1.5 ml of a boric acid solution was added; the concentration of the boric acid solution was chosen so as to provide 120 ppm boron in the mixed solution before any dilution. The results obtained, shown as a graph in FIG. 9, were:

| | | Viscosities with | | Viscosities with | |
|---|---|---|---|---|---|
| HPG concentration | | nanoparticles | | boric acid | |
| lbs per 1000 | gm/ | mPa · s | mPa · s | mPa · s | mPa · s |
| US gallons | liter | at 25 s⁻¹ | at 100 s⁻¹ | at 25 s⁻¹ | at 100 s⁻¹ |
| 33 | 4.05 | 1870 | | 1940 | |
| 16.5 | 2.02 | 767 | 445 | 269 | 104 |
| 11.75 | 1.44 | 400 | 154 | | |
| 11 | 1.34 | 230 | 92 | 11.7 | 16.9 |

It is apparent from these results that the nanolatex leads to a viscosity which is equal to or higher than the viscosity achieved with boric acid even though the boron concentration provided by the boric acid solution was about 40 times greater. Moreover, the nanoparticles were able to bring about cross-linking and thickening when the HPG concentration was only about 1.3 gm/liter, corresponding to 11 lbs per 1000 US gallons, whereas boric acid gave low viscosity (at both shear rates) indicating that the boric acid gave negligible cross-linking at this low concentration of HPG.

### Example 7

A series of tests was carried out using a solution of HPG prepared as in Example 6 above, and diluted with an equal volume of water, so as to contain 2 gm/liter HPG, which is equivalent to 16.5 lbs HPG per 1000 US gallons, and 1 wt % DTAB. Varying amounts of nanoparticles suspension were added and viscosities were determined as in the previous Example. The results were:

| | |
|---|---|
| Nanoparticles | Viscosity |

| concentration | mPa · s | mPa · s |
|---|---|---|
| (as ppm boron) | at 25 s⁻¹ | at 100 s⁻¹ |
| 1.3 | 683 | 328 |
| 1.5 | 767 | 445 |
| 1.7 | 843 | 366 |
| 1.9 | 783 | 493 |

### Example 8

The stability of the nanoparticles is very dependent on the presence of a surfactant such as the DTAB used during the synthesis of the particles in Example 1. The effect of surfactant present in the HPG solution before the addition of the nanoparticles was investigated, using the procedure of Example 6 but varying the surfactant concentration in the HPG solution.

A series of experiments was carried out using 15 ml HPG solution with an HPG concentration of 16.5 lbs per 1000 US gallons (2 g/liter) as in the previous Example and sufficient suspension of nanoparticles to provide a boron concentration of 1.3 ppm. The concentration of DTAB in the HPG solution was varied, with the following results:

| | |
|---|---|
| | Viscosities with |
| DTAB | nanoparticles |

| concentration | mPa · s | mPa · s |
|---|---|---|
| (wt %) | at 25 s⁻¹ | at 100 s⁻¹ |
| 0 | 531 | 249 |
| 0.5 | 792 | 456 |
| 1 | 864 | 480 |
| 2 | 742 | 332 |
| 5 | 649 | 317 |

Without DTAB in the HPG solution, the viscosity was rather low and the gel rather unstable. Including DTAB led to a stable gel of higher viscosity which reached a maximum at 1 wt % DTAB.

The procedure was repeated using other concentrations of HPG and also using cetyl trimethyl ammonium bromide (CTAB) in place of DTAB. CTAB has a lower critical micelle concentration than DTAB and could be used in lower amounts. The results were

| HPG concentration | | | | Viscosity | |
|---|---|---|---|---|---|
| lbs per 1000 | gm/ | | | mPa · s | mPa · s |
| US gallons | liter | Surfactant | | at 25 s⁻¹ | at 100 s⁻¹ |
| 33 | 4.05 | 2 | wt % DTAB | 1870 | |
| 33 | 4.05 | 0.05 | wt % CTAB | 1980 | |
| 16.5 | 2.02 | 2 | wt % DTAB | 864 | 480 |
| 16.5 | 2.02 | 0.05 | wt % CTAB | 774 | 368 |
| 11 | 1.34 | 2 | wt % DTAB | 230 | 92 |
| 11 | 1.34 | 0.05 | wt % CTAB | 348 | 162 |

### Example 9

An HPG solution with an HPG concentration of 2 gm/liter equivalent to 16.5 lbs per 1000 US gallons, and a surfactant concentration of 1 wt % DTAB was thickened with a suspension of nanoparticles made as in Example 1, in sufficient quantity to provide a boron concentration of 1.9 ppm.

This thickened solution was subjected to oscillation tests using the Bohlin rheometer and the values of elastic and viscous modulus were determined to be approximately 0.2 Pa and 70 Pa respectively. An elastic modulus which is well above the viscous modulus, as observed here, is a characteristic of a viscoelastic composition.

The same composition was then subjected to varying shear rates while viscosity was measured, so as to investigate properties of shear thinning and shear recovery. Shear was progressively increased from 0.1 sec⁻¹ to 100 sec⁻¹ then maintained at 100 sec⁻¹ for 20 minutes. After this time the shear rate was reduced in steps to 25 sec⁻¹, increased again to 100 sec⁻¹ for a further 20 minutes and again reduced in steps to 25 sec⁻¹ and increased again to 100 sec⁻¹. The measured viscosities were as follows:

| | |
|---|---|
| Shear rate applied | Viscosity |
| (sec⁻¹ for stated time) | (Pa · sec) |

| | | |
|---|---|---|
| 0.1 | sec⁻¹ for 100 sec | 19.61 |
| 0.3 | sec⁻¹ for 100 sec | 5.96 |
| 1 | sec⁻¹ for 100 sec | 2.94 |
| 3 | sec⁻¹ for 100 sec | 2.13 |
| 10 | sec⁻¹ for 100 sec | 1.60 |
| 25 | sec⁻¹ for 100 sec | 0.88 |
| 100 | sec⁻¹ for 20 minutes | 0.49 |
| 75 | sec⁻¹ for 100 sec | 0.52 |
| 50 | sec⁻¹ for 100 sec | 0.56 |
| 25 | sec⁻¹ for 100 sec | 0.60 |
| 50 | sec⁻¹ for 100 sec | 0.50 |
| 75 | sec⁻¹ for 100 sec | 0.47 |
| 100 | sec⁻¹ for 20 minutes | 0.45 |
| 75 | sec⁻¹ for 100 sec | 0.47 |
| 50 | sec⁻¹ for 100 sec | 0.51 |
| 25 | sec⁻¹ for 100 sec | 0.56 |
| 50 | sec⁻¹ for 100 sec | 0.50 |
| 75 | sec⁻¹ for 100 sec | 0.46 |
| 100 | sec⁻¹ for 100 sec | 0.41 |

These results show that the composition was shear thinning, and that there was recovery of viscosity after both periods of relatively high (100 sec⁻¹) shear.

### Example 10

Nanoparticles prepared as in Example 1 were again used to crosslink unmodified guar. The procedure was largely the same as in Example 6. Guar solution was prepared by mixing guar powder with de-ionised water containing the cationic surfactant DTAB while stirring for two hours. The amounts were chosen to provide a solution containing guar at a concentration of 2 gm/liter, equivalent to 16.5 lbs per 1000 US gallons, and DTAB at 1 wt %. Nanolatex prepared as in Example 1 was added so that there was 1.5 ppm boron in the mixed solution. Portions of the resulting solution were diluted with additional water to give solutions of lower HPG, boron and DTAB concentration.

In comparative experiments a boric acid solution was added so as to provide 60 ppm boron in a solution with 2 gm guar per liter, equivalent to 16.5 lbs per 1000 US gallons in the mixed solution. Portions of the solution were again diluted with additional water. The results obtained were:

| | | Viscosities with | | Viscosities with | |
|---|---|---|---|---|---|
| Guar concentration | | nanoparticles | | boric acid | |
| lbs per 1000 | gm/ | mPa · s | mPa · s | mPa · s | mPa · s |
| US gallons | liter | at 25 s⁻¹ | at 100 s⁻¹ | at 25 s⁻¹ | at 100 s⁻¹ |
| 16.5 | 2.02 | 1030 | 483 | 857 | 508 |
| 11 | 1.34 | 589 | 313 | 580 | 246 |
| 8.25 | 1.01 | 256 | 97 | 106 | 46.9 |

It is apparent that the nanolatex leads to similar and sometimes higher viscosity, even though the boron concentration provided by the boric acid solution was much higher than that provided by the nanoparticles.

### Example 11

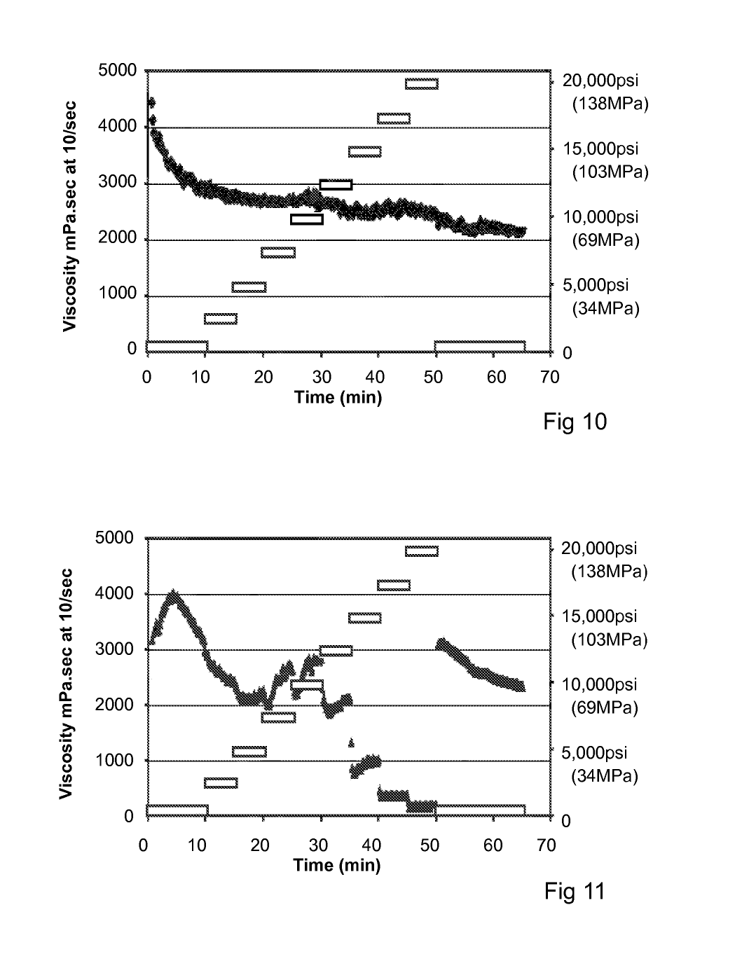

Viscosity measurements were carried out using a high pressure, high temperature (HPHT) rheometer (Grace Instrument Co. Houston, Model 7500) which was able to measure viscosity of a sample under pressure. A gel was made as in Examples 3 and 4 above, containing 0.36 wt % guar (equivalent to a concentration of 30 lbs per 1000 US gallons) and nanolatex providing 3 ppm boron, as pressure was raised in steps to 20,000 psi (138 MPa) while temperature was maintained at room temperature of approximately 25° C. The results are shown in FIG. 10, which is a plot of viscosity measurements at a shear rate of 10 sec⁻¹ taken at frequent intervals during the duration of the experiment. The applied pressures are shown by horizontal bars and pressure values are shown on the axis at the right hand side, both in pounds per square inch and in MPa. It can be seen that viscosity remained above 2000 mPa·s even at the maximum applied pressure of 20,000 psi (138 MPa).

A comparative test was carried out on a similar guar gel thickened with inorganic borate to provide 60 ppm boron. The results are shown in FIG. 11. It can be seen that as pressure was raised, this gel which was crosslinked with inorganic borate lost its viscosity at pressures of 15,000 psi (103 MPa) and above. When pressure was reduced to zero, the viscosity recovered.

In another comparative experiment, a similar guar gel was likewise crosslinked with inorganic borate but nanolatex without boron, designated NL-CH₂Cl in Example 1, was also included in addition to the borate so as to provide a similar concentration of nanoparticles as in the composition thickened with boron-containing nanoparticles. Under pressure of 15,000 psi (103 MPa) and above this gel also lost its viscosity, showing that retention of viscosity under pressure is not achieved by the presence of these boron-free nanoparticles.

### Example 12

A sample of aqueous guar solution, crosslinked with nanoparticles prepared as in Example 1 was subjected to a test using the same HPHT rheometer as in the previous Example, but viscosity was measured as both temperature and pressure were raised.

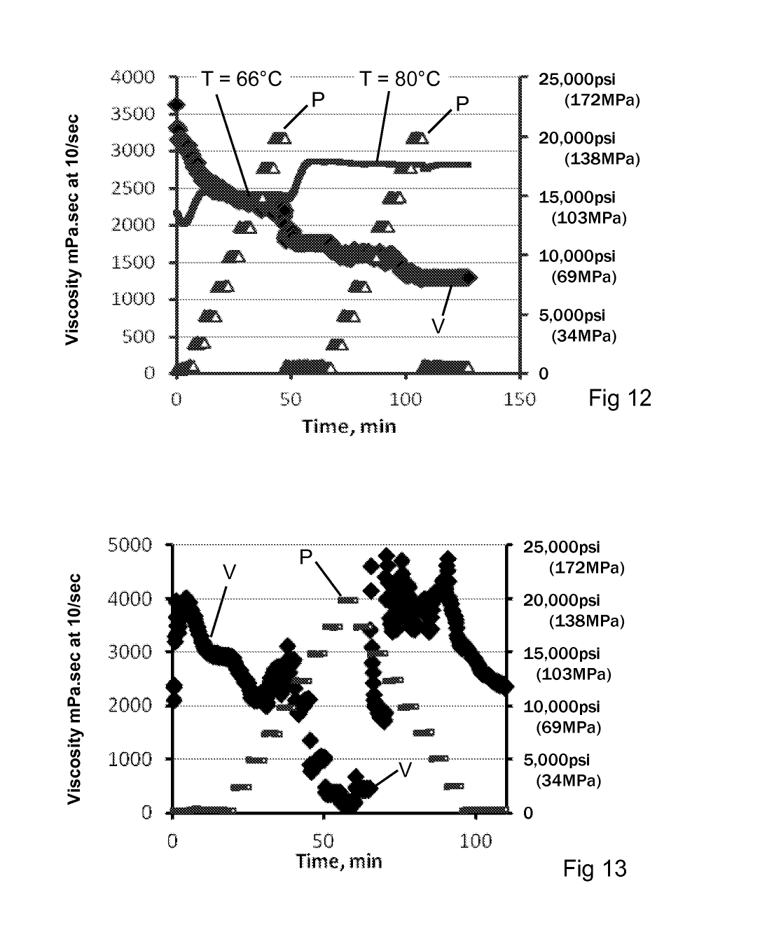

The solution contained unmodified guar at a concentration of 0.48 wt % (4.8 gm/liter, equivalent to 40 lbs per 1000 US gallons) and 0.05 wt % CTAB It was thickened by adding 10% by volume of a nanoparticles suspension prepared as in Example 1 so that the boron concentration in solution was 3 ppm. The pH was raised to 11.5 to allow cross linking to take place. Pressure was then increased in steps while temperature was held at about 60° C., reduced to zero and then increased in steps again while temperature was held at 80° C. and finally returned to zero. Pressure, temperature and viscosity at a shear rate of 10 sec⁻¹ were measured at each pressure step. The results are given in the following table and shown in FIG. 12.

| | Elapsed Time | Temp | Pressure | Viscosity |
|---|---|---|---|---|
| Step No | (min) | (° C.) | (MPa) | (mPa · sec) |
| 1 | 7.2 | 59.4 | 4.21 | 2858.3 |
| 2 | 12.2 | 67.2 | 17.99 | 2594.5 |
| 3 | 17.2 | 65.0 | 33.15 | 2547.6 |
| 4 | 22.3 | 65.0 | 51.12 | 2417.7 |
| 5 | 27.3 | 66.7 | 68.10 | 2328.8 |
| 6 | 32.3 | 65.6 | 85.03 | 2312.8 |
| 7 | 37.3 | 66.1 | 102.51 | 2225.9 |
| 8 | 42.3 | 66.1 | 119.47 | 2164.9 |
| 9 | 47.3 | 65.6 | 136.54 | 2010.1 |
| 10 | 67.4 | 81.7 | 3.31 | 1764.3 |
| 11 | 72.4 | 81.1 | 16.81 | 1602.5 |
| 12 | 77.4 | 80.6 | 33.44 | 1616.5 |
| 13 | 82.4 | 80.0 | 50.61 | 1604.5 |
| 14 | 87.4 | 80.6 | 67.94 | 1571.5 |
| 15 | 92.4 | 80.0 | 85.10 | 1603.5 |
| 16 | 97.5 | 80.0 | 102.42 | 1435.6 |
| 17 | 102.5 | 80.0 | 119.34 | 1366.7 |
| 18 | 107.5 | 80.0 | 136.89 | 1301.8 |
| 19 | 127.5 | 80.0 | 3.73 | 1300.8 |

By comparing steps 1 and 10 in the table, it can be seen that an increase in temperature led to a reduction in viscosity, which happens with many thickening systems. However, it is apparent from steps 2 to 10 at a constant 66° C. and again from steps 11 to 18 at 80° C. that as the pressure was raised to a high value, the viscosity did not collapse but merely declined slightly.

In FIG. 12, which is the graphical presentation of these results, the pressures can be seen as two sets of rising steps P and pressure values are shown on the right hand vertical axis. Viscosity measurements taken at frequent intervals appear as thick line V and temperature is indicated by a thinner line T.

A comparative experiment was carried out using the same rheometer. The solution contained unmodified guar at a concentration of 0.36 wt % (3.6 gm/liter equivalent to 30 lbs per 1000 US gallons) and 0.05 wt % CTAB It was thickened by adding 10% by volume of a borax solution so that the boron concentration in solution was 55 ppm. Again pH was raised to 11.5 to allow crosslinking. For this test the temperature was maintained constant at 37° C. The results are shown in FIG. 13 and summarized in the following table.

| | Elapsed Time | Pressure | Viscosity |
|---|---|---|---|
| Step No | (min) | (MPa) | (mPa · sec) |
| 1 | 20 | 1.64 | 2889.2 |
| 2 | 25 | 16.55 | 2426 |
| 3 | 30 | 33.57 | 2276.9 |
| 4 | 35.1 | 50.86 | 2630.1 |
| 5 | 40.1 | 67.78 | 2857.2 |
| 6 | 45.1 | 84.98 | 2124.9 |
| 7 | 50.1 | 102.41 | 1023.4 |
| 8 | 55.1 | 119.84 | 379.2 |
| 9 | 60.1 | 136.67 | 199.1 |
| 10 | 65.2 | 119.8 | 458.2 |
| 11 | 70.2 | 102.83 | 1869.8 |
| 12 | 75.2 | 85.27 | 3799.6 |
| 13 | 80.2 | 68.19 | 3533.5 |
| 14 | 85.2 | 51.68 | 3438.4 |
| 15 | 90.2 | 34.84 | 4129.7 |
| 16 | 95.3 | 17.27 | 3085.3 |
| 17 | 110.3 | 1.93 | 2342 |

It can be seen from FIG. 13 and from the above table that when the pressure exceeded 100 MPa, the viscosity dropped considerably, and was at a low value when the pressure was at or above 119 MPa. By contrast, when crosslinking with nanoparticles, the viscosities were much higher at these pressures, even though temperatures were higher. Thus, crosslinking with nanoparticles achieved a pressure tolerance which could not be obtained when crosslinking with borate.

### Example 13

Samples of NL-CH₂Cl latex were prepared as in Example 1 and then functionalized with each of

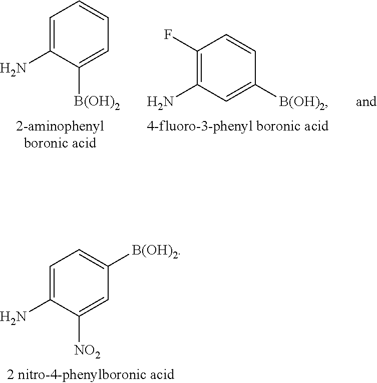 [SMILES: Nc1ccccc1B(O)O ; Nc1cc(B(O)O)ccc1F ; Nc1ccc(B(O)O)cc1[N+](=O)[O-]]

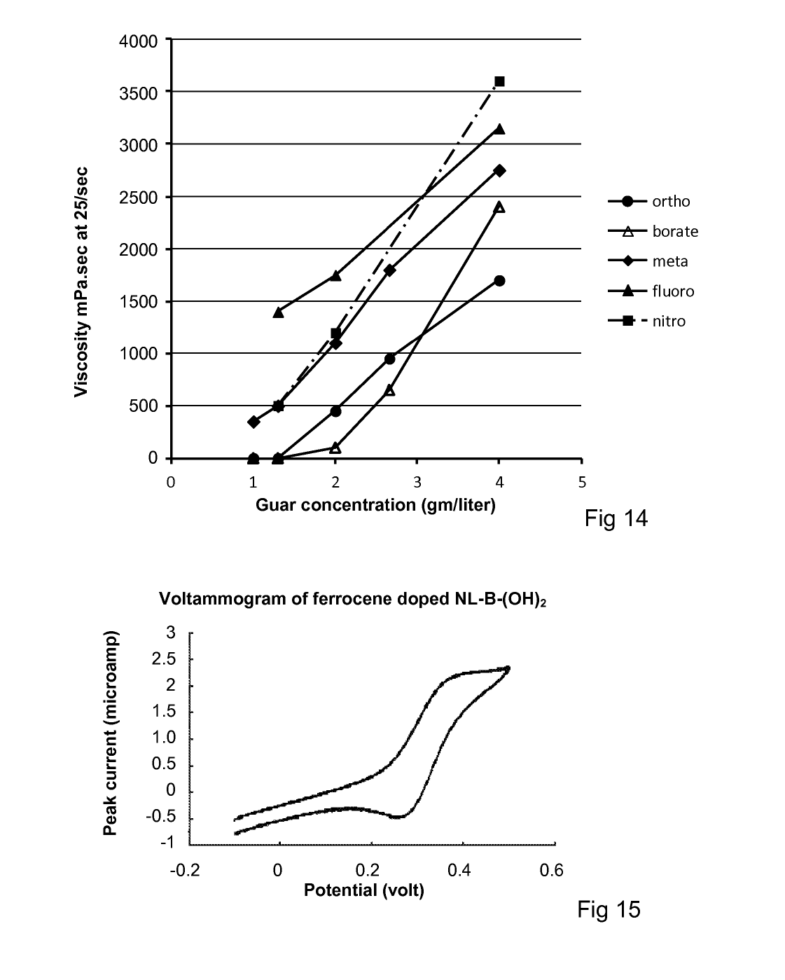

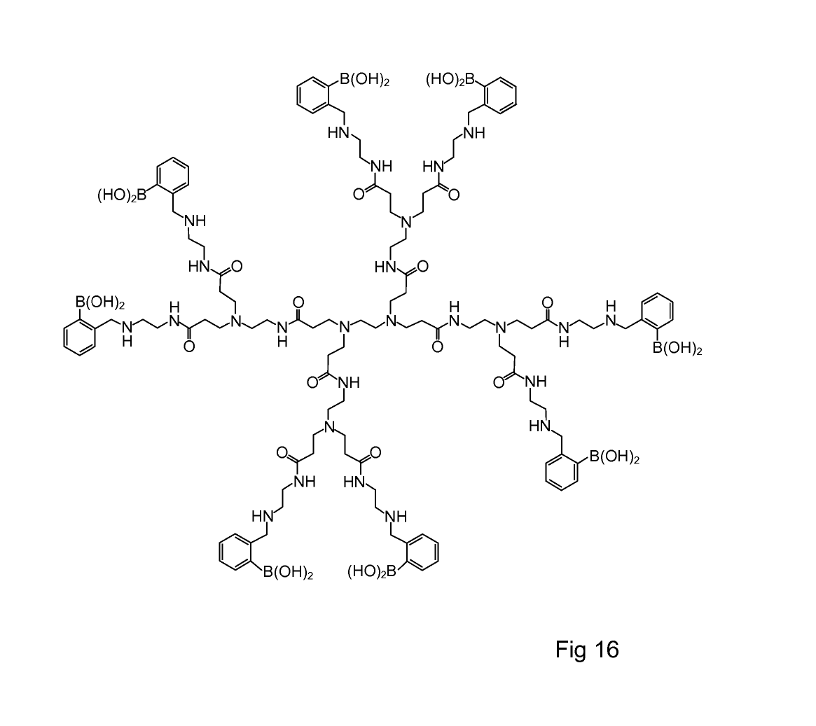

The functionalized nanolatices were purified as in example 1 and used to crosslink guar by the procedures in Example 3. It was found that the nanolatex made using the 2-aminophenyl compound gave maximum viscosity when proportions were 7.5 ppm boron to 0.36 wt % guar. The nanolatices made using the 4-fluoro-3-aminophenyl boronic acid and 2-nitro-4-amino-phenylboronic acid gave maximum viscosity when the proportions were 3 ppm boron to 0.36 wt % guar. The viscosities, at 25 sec⁻¹ shear rate and ambient temperature are shown graphically in FIG. 14.

The effect of pressure on viscosity was tested as in Example 10 for the nanolatices made using the 2-aminophenyl boronic acid and 2-nitro-4-amino-phenylboronic acid. In the case of the latter, the resistance to pressure was similar to that observed in example 10 (when the latex was made using 3-aminophenyl boronic acid). In the case of the nanolatex made with 2-aminophenyl boronic acid, viscosity was lost under pressure, much as occurs with borate. This was attributed to steric hindrance of the boric acid groups located in an ortho position to the attachment to the nanoparticle.

### Example 14

This example used a suspension of nanoparticles prepared as in Example 1. It also used the organic dye 1-[[2,5-Dimethyl-4-[(2-methylphenyl)azo]phenyl]azo]-2-naphthol which is known as oil red and which has a light absorption maximum at 521 nm.

600 μL of a 23 mM solution of oil red in dichloromethane was added to 5.2 g of the nanoparticles suspension, and the mixture was stirred with a magnetic stirrer for 12 hours, allowing slow evaporation of the dichloromethane. The remaining solution was filtered through a 0.2 μm pore size membrane. A clear pink solution was obtained. Some of this solution was mixed with octadecane but none of the dye migrated into the octadecane phase, consistent with the dye having been absorbed into the hydrophobic interior of the nanoparticles. This pink solution displayed a similar light-absorbance spectrum to that as observed previously in dichloromethane with a maximum absorbance found at 523 nm.

5 ml of HPG solution containing HPG at a concentration of 33 lbs per 100 US gallons (4.04 g/liter) and 2 wt % DTAB was crosslinked by adding 500 microliters of the nanoparticles suspension. This provided 3 ppm boron in the crosslinked fluid. The resulting gel was pink but in other respects did not differ from the crosslinked gel obtained in Example 5. When the gel was immersed in octadecane, the gel remained pink and the octadecane remained colourless.

### Example 15

This example also used a suspension of nanoparticles prepared as in Example 1. 600 μL of a 23 mM solution of vinyl ferrocene in dichloromethane was added to 5.2 g of the suspension of nanoparticles and the mixture was stirred with a magnetic stirrer for 12 hours, allowing slow evaporation of the dichloromethane. The resulting yellow suspension was subjected to voltammetry in a 3-electrode potentiometric cell with a glassy carbon working electrode. The voltammogram is shown in FIG. 14. As can be seen, there was an oxidative wave at +0.368V and reductive wave at +0.277V relative to a standard calomel reference electrode.

### Example 16

This example uses a dendrimer in which one amidoamine group has been attached to each of the four available sites on an ethylene diamine core and then two further amidoamine groups had been attached to each terminal amino group (1-PAMAM-dendrimer from Dendritech, available from Aldrich). This dendrimer had 8 amino groups at the exterior of the molecule. A phenyl boronic acid group was attached to each of these 8 sites at the exterior of the molecule, leading to the compound shown in FIG. 15. The diameter of this molecule is quoted by Dendritech as 2.2 nm. It will be appreciated that a closely similar procedure could be used to attach phenyl boronic groups to higher PAMAM dendrimers.

Synthesis was carried out as follows. 2.0 g of a 20 wt % solution in MeOH of generation 1 PAMAM Dendrimer (purchased from Aldrich 412384) were diluted in a further 20 mL of dry methanol and stirred at 60° C. in the presence of a 16-fold excess of 3-formylphenylboronic acid (720 mg) for 48 h under nitrogen gas atmosphere. The solution was then cooled to 0° C. (ice/water bath) and NaBH₄ (340 mg) was added portion-wise under a stream of nitrogen to the stirring mixture. The suspension was allowed to warm to room temperature and stirred for a further 8 h. 2M HCl (aq) was slowly added until no further gas was evolved and the solution was stirred for 2 h. The resulting crude material was neutralized with aqueous NaOH and diluted further with water (5 mL) and methanol (5 mL). The product precipitated out of the solution and was redissolved in methanol. To this was added an acidic solution to re-precipitate the product. The product was then filtered and re-dissolved in a mixture of methanol/water. The product was characterised by nmr.

Analysis by inductively coupled plasma mass spectroscopy (ICP-MS) found that the solution contained 1415 ppm boron.

30 microL of this solution was added to 15 mL of a guar solution (0.4 wt %, pH 11.4). This led to a solution of crosslinked guar containing about 2.8 ppm boron. Rheology tests were performed at ambient temperature. The values of viscosity, after equilibration for 100 sec were:

| Shear rates (s⁻¹) | Viscosity (mPa · s) |
|---|---|
| 10 | 7920 |
| 25 | 4000 |
| 100 | 457 |
| 700 | 56 |

The above text has explained and exemplified embodiments of the invention. Such description of embodiments is not intended to limit the scope of the invention as claimed by the following claims. Except where clearly inappropriate or expressly noted, features and components of different embodiments may be employed separately or used in any combination.

1-26. (canceled)

27. An aqueous fluid comprising an aqueous solution or dispersion of a polymer to thicken the fluid and a cross linking agent to enhance the viscosity of the fluid by crosslinking the polymer
wherein the crosslinking agent comprises supporting structures bearing functional groups to react with the polymer molecules, wherein the functional groups are covalently attached to the supporting structures, and wherein the crosslinking agent has a mean particle size in a range from 1 nm to 1000 nm.

28. A fluid according to claim 27, wherein the crosslinking agent has a mean particle size in a range from 2 nm to 200 nm.

29. A fluid according to claim 27, wherein the crosslinking agent has a mean particle size in a range from 5 nm to 100 nm.

30. A fluid according to claim 27, wherein the polymer concentration is in a range from 0.5 to 20 g/liter.

31. A fluid according to claim 27, wherein the polymer concentration is no more than 2 g/liter.

32. A fluid according to claim 27, wherein the supporting structures have the functional groups attached thereto through linking groups.

33. A fluid according to claim 27, wherein the number of functional groups on a supporting structure is at least 1000.

34. A fluid according to claim 27, wherein the quantity of cross linking agent is no more than 20% by weight of the polymer.

35. A fluid according to claim 27, wherein the supporting structures are rigid nanoparticles.

36. A fluid according to claim 34, wherein the nanoparticles comprise crosslinked organic polymer formed by polymerization of a mixture of monomers containing at least 20 mole % of a crosslinking monomer.

37. A fluid according to claim 35, wherein the nanoparticles comprise crosslinked organic polymer formed by polymerization of a mixture of monomers containing at least 20 mole % of a crosslinking monomer.

38. A fluid according to claim 35, wherein the nanoparticles comprises crosslinked organic polymer and the fluid also comprises a surfactant to stabilize the particles of crosslinking agent.

39. A fluid according to claim 27, wherein the polymer comprises a polysaccharide and the functional groups contain dihydroxy boron moieties.

40. A fluid according to claim 27, wherein the content of boron in the fluid is between 0.5 and 5 ppm by weight elemental boron.

41. A fluid according to claim 27, wherein the polymer is a polyacrylamide and the functional groups are phenolic.

42. A fluid according to claim 27, wherein the crosslinking agent includes a colored or fluorescent material.

43. A fluid according to claim 27, wherein the crosslinking agent includes a redox-active material.

44. A fluid according to claim 27, which is a paint composition containing suspended pigment.

45. A fluid according to claim 27, which is a cleaning composition containing detergent.

46. A fluid according to claim 27, which is a cosmetic composition.

47. A fluid according to claim 27, wherein the fluid is a wellbore fluid for delivery to a subterranean location.

48. A fluid according to claim 47, which is a fracturing fluid containing suspended proppant and a viscosity breaker to reduce the viscosity after a period of time.

49. A method of treatment of a wellbore or a formation penetrated by a wellbore, comprising pumping into the wellbore a fluid comprising an aqueous solution or dispersion of a polymer and a cross linking agent to enhance the viscosity of the fluid characterized in that the crosslinking agent comprises supporting structures bearing functional groups to react with the polymer molecules wherein the functional groups are covalently attached to the supporting structures, and wherein the crosslinking agent has a mean particle size in a range from 1 nm to 1000 nm.

50. A method according to claim 49, wherein the fluid pumped into the wellbore reaches a pressure of 80 MPa or more.

51. A method according to claim 49, wherein the fluid pumped into the wellbore reaches a pressure of 100 MPa or more.

52. A method according to claim 49, wherein the crosslinking agent has a mean particle size in a range from 2 nm to 200 nm.

53. A method according to claim 49, wherein the crosslinking agent has a mean particle size in a range from 5 nm to 100 nm.

54. A method according to claim 49, wherein the polymer concentration is in a range from 0.5 to 20 g/liter.

55. A method according to claim 49, wherein the polymer concentration is no more than 2 g/liter.

56. A method according to claim 49, wherein the supporting structures have the functional groups attached thereto through linking groups.

57. A method according to claim 49, wherein the number of functional groups on a supporting structure is at least 1000.

58. A method according to claim 49, wherein the quantity of cross linking agent is no more than 20% by weight of the polymer.

59. A method according to claim 49, wherein the supporting structures are rigid nanoparticles.

60. A method according to claim 58, wherein the nanoparticles comprise crosslinked organic polymer formed by polymerization of a mixture of monomers containing at least 20 mole % of a crosslinking monomer.

61. A method according to claim 59, wherein the nanoparticles comprise crosslinked organic polymer formed by polymerization of a mixture of monomers containing at least 20 mole % of a crosslinking monomer.

62. A method according to claim 59, wherein the nanoparticles comprises crosslinked organic polymer and the fluid also comprises a surfactant to stabilize the particles of crosslinking agent.

63. A method according to claim 49, wherein the polymer comprises a polysaccharide and the functional groups contain dihydroxy boron moieties.

64. A method according to claim 49, wherein the content of boron in the fluid is between 0.5 and 5 ppm by weight elemental boron.

65. A method according to claim 49, wherein the polymer is a polyacrylamide and the functional groups are phenolic.

66. A method according to claim 49, wherein the crosslinking agent includes a colored or fluorescent material.

67. A method according to claim 49, wherein the crosslinking agent includes a redox-active material.
